(19) United States
(12) Patent Application Publication
(10) Pub. No.: US 2003/0024922 A1
(43) Pub. Date: Feb. 6, 2003

(54) Table top food warming system

(75) Inventors: Keith A. Stanger, New Port Richey, FL (US); David S. Schwerzler, Chagrin Falls, OH (US); Victor D. Saltenis, Kirtland, OH (US)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: Cleveland Range

(21) Appl. No.: 10/206,146

(22) Filed: Jul. 26, 2002

Related U.S. Application Data
(60) Provisional application No. 60/308,316, filed on Jul. 27, 2001.

(51) Int. Cl. H05B 3/68; A21B 1/22

(52) U.S. Cl. 219/449.1; 392/399; 219/401

(57) ABSTRACT

The present invention generally relates to a system and method for a table top food warming system for applying steam to various sized portions of food for cooking of the food, as well as injecting steam into the food itself to increase its internal temperature. A preselected amount of water is transported via a pump to a preheated steam chamber. Upon contact with the preheated steam chamber, the water is vaporized and exits as steam through holes in a portion plate holding the food serving.

The present invention generally relates to a system and method for a table top food warming system for applying steam to various sized portions of food for cooking of the food, as well as injecting steam into the food itself to increase its internal temperature. The food warming system may be a stand alone unit or a mini-steamer assembly disposed on a weight measurement device, such as, a load cell or other scale device.

### BACKGROUND OF THE INVENTION

Foods warmed using steam may be warmed more quickly and are generally more pleasing in appearance and taste than food cooked in other environments. However, known steam warming devices and methods are not without problems. For example, some steamers require a prolonged setup and preheating operation when not used, or when used intermittently. This setup or priming time results in a slow food preparation time. Slow food preparation is especially critical in fastfood restaurants.

Other steamers do not provide a water supply that allows for prolonged operation of the steamer. Frequent refilling of the steamer with water results in an unacceptable down time of the food preparation operation. In addition, other steamers do not provide for easy and remote operation of the steamer so that the operator can avoid contact with the steam during the warming operation.

Another significant drawback of known steamers is that the amount of steam released in contact with the food cannot be controlled. Some steamers warm the food using an unlimited supply of water, and the steaming may only be halted by turning off the steamer. This can result in overcooking of the food.

The present invention also provides many additional advantages which shall become apparent as described below.

### SUMMARY OF THE INVENTION

The present invention generally relates to a system and method for a table top food warming system which includes modules which work together to provide a method of applying steam to various sized portions of food for cooking of the food. The food warming system may also inject steam into the food itself to increase its internal temperature. The food warming system may be a stand alone unit or a mini-steamer assembly disposed on a weight measurement device, such as, a load cell or other scale device.

The present invention provides a system for heating food including a steaming module for converting a liquid to a vapor. The steaming module may include a heat source positioned beneath a cavity and a pump module for transporting liquid to the cavity from a reservoir. In addition, the steaming module may include a portion plate having holes positioned above a steaming module. Liquid transported to the cavity is vaporized upon contact with the heat source, and the vapor exits through the holes of the food plate to thereby warm the food.

The present invention may also use a steaming module for warming food which includes a steamer head in fluid communication with a liquid cavity. The steam module may also include a portion plate that is removably attached to the steaming module. The portion plate may have holes and can be insulated from the steamer head by an insulating ring positioned on the steamer head. The steaming module may include a heating element for heating the steamer head to a preselected temperature. The steaming module may also include an inlet port for admitting a liquid into the liquid cavity in contact with the steamer head; where the liquid is vaporized and the vapor exits through the portion plate holes.

The present invention provides a method for providing heated vapor to warm food. The method includes the steps of providing a portion plate positioned above a heating element. Preheating the heating element above the boiling point of the liquid. Compressing an inlet tube to transport the liquid within the tube into contact with the heating element. Converting the liquid into vapor and directing the vapor through the holes of the portion plate, whereby food, placed on the portion plate, is warmed

The present invention may also provide a method for providing heated moisture to food by providing a steamer head in liquid communication with a storage area for holding a liquid. The method may include preheating the steamer head to a boiling point above the boiling point of the liquid. Transporting a preselected amount of liquid to the storage area. Vaporizing the liquid in the storage area and directing the vapor toward a food plate that is thermally insulated from the steamer head. The food, when placed on the food plate, is then contacted and warmed by the vapor.

The steamer according to the present invention is designed to warm individual food or product servings to a “piping hot” serving temperature in just seconds, increasing customer satisfaction. The food product can go from the preparation stage to the mini steamer and right to the customer.

The unique food warmer system according to the present invention also provides the following advantages and features:

Modular tabletop design allows the mini-steamer location to be more adaptable to the existing counter constraints. Reservoir and pump module can be located beneath the counter to conserve counter space.

A remote operating switch also assists locating the steamers operating control to meet the needs of each location.

Standard 3-prong cord powered unit and low power requirements allow for easy installation and operation of the mini-steamer off of a standard 115 V, 20 amp electric circuit.

Integral re-settable circuit breaker protects the mini-steamer's pump system.

Equipped with easily visible “Heater ON” and “Ready” lights.

Pre-measured steam production helps to insure a consistent product.

Standby heat feature insures the mini-steamer is always ready for use.

All stainless steel construction and dishwasher safe removable cooking head allow for easy cleaning.

Reservoir fed design can be used with distilled water in areas of poor water quality to minimize equipment maintenance.

Conserves water, for example, one gallon of water is enough to warm over 1200 three oz. servings of meat.

These and other advantages will be apparent from the following detailed description of the invention, drawings, and claims.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 is a perspective view of one embodiment of the food warming system according to the present invention;

FIG. 2 is a perspective view of the water reservoir of FIG. 1;

FIG. 3 is a front perspective view of the pump module of FIG. 1;

FIG. 4 is a rear perspective view of the pump module of FIG. 1;

FIG. 5 is a front perspective view of the remote steam switch of FIG. 1;

FIG. 6 is a front perspective view of the steaming module unit of FIG. 1;

FIG. 7 is an exploded front view of the disassembled steaming module of FIG. 1;

FIG. 8 is a front perspective view of the steaming module of FIG. 1 with the steamer head plate removed;

FIG. 9(a) is a top planar view of the portion plate of FIG. 1;

FIG. 9(b) is a bottom planar view of the portion plate of FIG. 1;

FIG. 10 is an exploded view and top view of the steaming module according to another embodiment of the present invention;

FIG. 10(a) is a top planar view of the portion plate of the steaming module of FIG. 10;

FIG. 10(b) is a side view of the portion plate of FIG. 10a;

FIG. 10(c) is a top planar view of the steaming module of FIG. 10(d);

FIG. 10(d) is a side view of the steaming module according to FIG. 10;

FIG. 10(e) is a bottom view of the steaming module of FIG. 10(d);

FIG. 11 is a cross-sectional view along line 11-11 of the portion plate of FIG. 10(a) of the steaming module of FIG. 10;

FIG. 12 is a cross-sectional view along line 12-12 of the steaming module of FIG. 10(c) of the steaming module of FIG. 10;

FIG. 13 is a top planar view of a load cell used in accordance with the present invention; and

FIG. 14 is a front perspective view of the load cell of FIG. 13.

### DETAILED DESCRIPTION OF THE PREFERRED EMBODIMENTS

Referring now to FIG. 1 food warming system 10 of the present invention, may include a water reservoir 12, a pump module 14 and a steaming module 16. In addition, the warming system 10 may also include an operating switch 18.

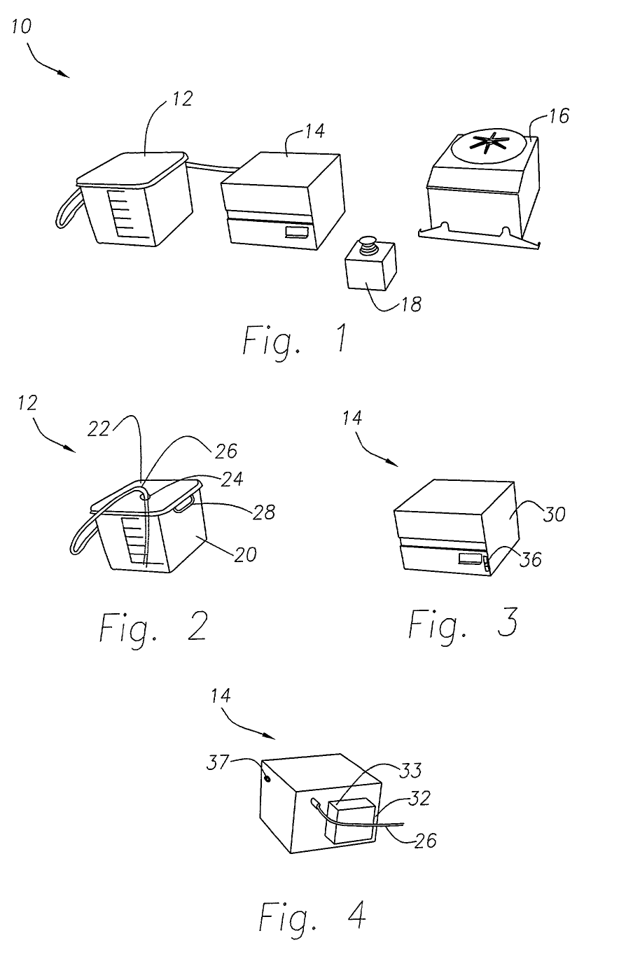

The reservoir 12 may include a container 20 capable of holding water or another liquid as shown in FIG. 2. The reservoir 12 may be made of any suitable material, e.g. metal or plastic. The reservoir 12 may include a cover 22 which may be placed on the container 20 during operation of the warming system 10. The cover 22 may be removed for cleaning of the reservoir 12. The reservoir 12 includes a fill port 24 shaped to receive a water transport tube 26. The fill port 24 may be positioned through or on the cover 22, or on or through the container 20. The tube 26 is used to transport a liquid, e.g. water, from the water reservoir 12 to the pump module 14. The tube 26 may pass through the fill port 24, or through some other portion of the reservoir 12. The tube 26 may extend into the container 20, or an additional tube (not shown) may be connected from the port 24 into the container. In addition, the water reservoir 12 may include handles 28 for aiding in the lifting of the reservoir 12.

The pump module 14 may include a housing 30 that encloses a pump 32 as shown in FIGS. 3 and 4. The pump 32 may include a pump housing 33. The pump module 14 is in contact with, or connected to, the tube 26 or tubes 26. The tube 26 transport liquid from the water reservoir 12 to the steaming module 16, via the pump module 14. The pump 32 may be any suitable pump, preferably a peristaltic pump. The tube 26 is a single tube, if a peristaltic pump is used, or two separate tubes, if a different type of pump is used. The pump 32, when operated, moves water or liquid from the reservoir 12 to the steaming module 16.

The pump module 14 may include a timing device (not shown), such as an adjustable timer, that controls the amount of water sent to the steaming module 16 for each warming cycle. For example, the timing device can activate the pump 32 for a certain time period which causes a preselected amount of water to be transported to the steaming module 16. The preselected amount of water is based on the length of time the pump 32 operates, as controlled by the timing device. Controlling the amount of water being sent to the steaming module 16 prevents the steaming module 16 from being “flooded” by a too-rapid operation.

The pump module 14 preferably includes a peristaltic pump. A peristaltic pump is used because the pump squeezes the tubing to move the water, but the pump components do not come in contact with the water, and thus do not require cleaning. Other types of pumps could be used for this function, but they will require additional cleaning. In another embodiment of the invention, the pump may be mounted on or within the reservoir 10.

The pump module 14 includes an ON/OFF switch 36. The ON-OFF switch 36 may be positioned on the exterior of the pump module 14 as shown in FIG. 3. The pump module 14 may also include a pump reset switch 37. The ON-OFF switch 36 may also be mounted in other locations, such as in the exterior of the pump module 14 or the exterior of the steaming module 16.

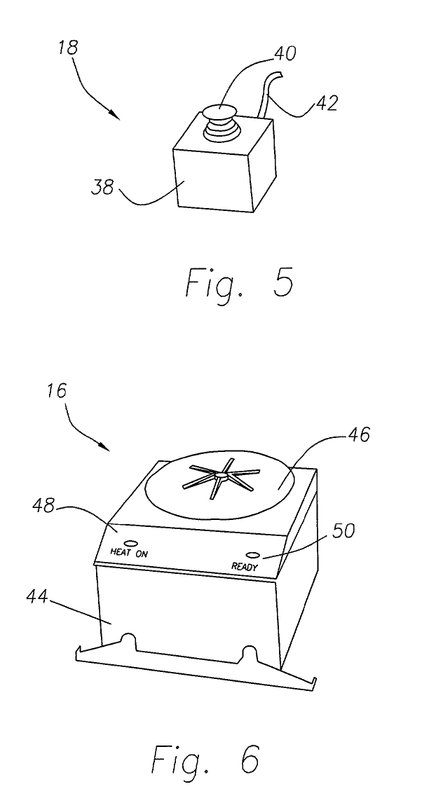

The operating switch 18 or heat switch of the present invention, may include a housing 38 and an activation button 40 or switch as shown in FIG. 5. The button 40 is used to start the pump 32. FIG. 5 shows the operating switch 18 as a remote operating switch that includes a connection 42 to the pump module 14. The operating switch 18 may also be placed in other locations proximate the warming system 10, such as mounted on the exterior of the pump module 14, mounted on the exterior of the steaming module 16, or positioned in a remote location.

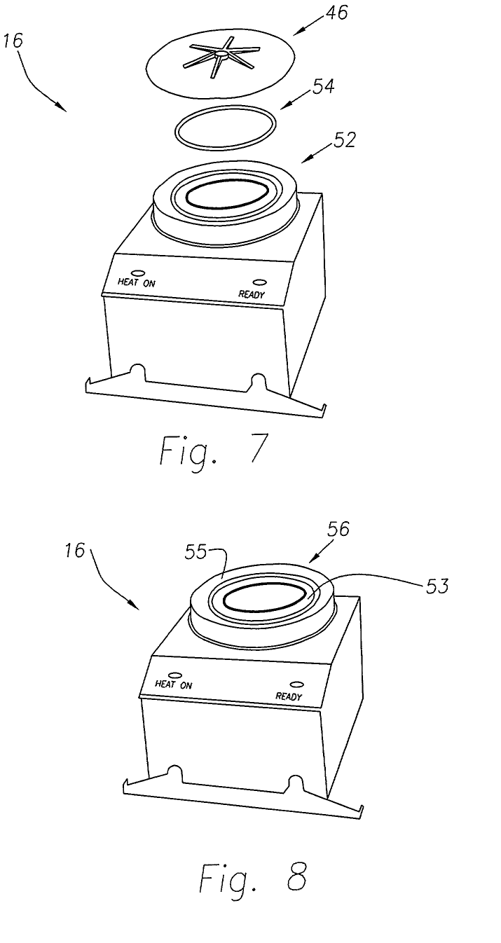

The steaming module of the present invention is shown assembled in FIG. 6, disassembled in FIG. 7, and with the steam plate 46 removed in FIG. 8. The steaming module 16 includes an enclosure 44 or housing. The steaming module 16 also includes a steam plate 46 or portion plate. The steam plate 46 may be any suitable material, such as stainless steel. The steaming module 16 may include a terminal block (not shown) for electrical connections. The steaming module 16 may include a HEAT ON light 48 or indicator light and/or a READY light 50 or indicator light.

The HEAT ON light 48 may illuminate whenever the ON-OFF switch 36 is in the ON position. The HEAT ON light 48 may be located on the exterior of the front of the steaming module 16 as shown in FIG. 6. The HEAT ON light 48 may also be mounted other locations, such as in the exterior of the pump module 14 or the exterior of the steaming module 16.

The READY light 50 may illuminate whenever the ON-OFF switch 36 is in the ON position. The READY light 50 may be located on the exterior of the steaming module as shown in FIG. 6. The READY light 50 may also be mounted other locations, such as in the exterior of the pump module 14 or the exterior of the steaming module 16.

The steaming module 16 includes a means for applying heat to the liquid transported to the steaming module 16. The means may be any suitable means such as a heating element 52 or a steamer head. The means may be any suitable material, such as, aluminum. For example, the heating element 52 may be an aluminum block. The steaming module 16 raises the temperature of liquid received from the reservoir 12 above the liquid boiling point, in order to convert the liquid to vapor. For example, if the liquid is water, the liquid will be brought in contact with the preheated heating element 52 in order to elevate the water temperature above the boiling point and convert the water to steam. The heating element 52 is heated above the boiling point of water so that when the water contacts the preheated element, the water rapidly converts to steam, or flashes steam.

The steaming module 16 may include an inlet connection (not shown) for the tube 26, and may include a shutdown device (not shown) to shut off the heating element 52 source if the temperature exceeds a pre-set value.

The steam plate 46 or portion plate may be removably attached to the steaming module 16. The steam plate 46 is separated from the exterior of the steaming module 16 by a ring 54 of thermal insulating material to reduce heat transfer to the enclosure. The ring 54 may be any suitable thermal insulating material, preferably teflon, or may be nylon, zytel, etc. The steam plate 46 and ring 54 may be retained on the enclosure by use of mechanical fasteners (not shown). The heating element 52 may include an upper circular wall that includes a seated pocket 53 along the top of the wall, shaped to receive the ring 54. The ring 54 may be slipped into a pocket 53 on the heating element 52 or steamer head. The ring 54 forms a seal between the steam plate 46 and the heating element 52 to retain most of the gas from the transport (injection shot) of the liquid into the steam chamber 56.

The steaming module 16 includes a steam chamber 56 formed within the boundary of the heating element 52, including the space within the upper wall 55 of the heating element 52, and the base of the portion plate 46. The steam chamber 56 collects and retain the preselected amount of liquid delivered by the pump 32. The liquid is removed from the reservoir 12 and transported to the steam chamber 56. The steam plate 46 may be removably attached to the steaming module 16 in order to form a seal with the heating element 52 and the ring 54, to prevent the steam from leaking out of the steam chamber 56 underneath the portion plate 46.

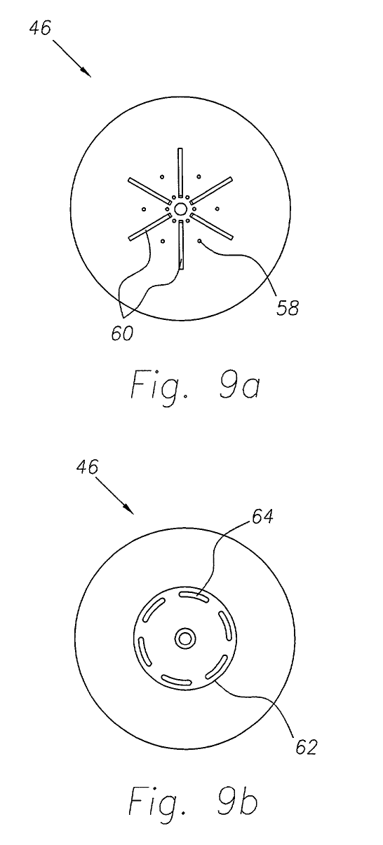

The steam plate 46 or portion plate of the present invention include holes 58 or openings as shown in FIGS. 9(a) and 9(b). The holes 58 allow the steam to exit the steam chamber 56. The holes 58 may be patterned in any suitable matter. The steam plate 46 can include a means of keeping the food portion from lying flat on the plate 46, to allow the steam access to a larger amount of food surface, thus improving heat transfer and reducing cycle time. The means may be any suitable means, such as fins 60. For example, the steam plate 46 may include six small fins 60 on the top plate surface to support the food or product serving and increase the contact area between the food or product serving and the steam. The steam plate 46 may also include a diverter plate 62 attached to the bottom of the steam plate 46. The diverter plate 62 prevents water from contacting the food product on the fins 60. For example, the steam will exit the steam chamber first through the diverter plate holes 64, and then through the steam plate holes 58.

Different types of food and/or different portion sizes can be accommodated by adjusting the timing device 34 of the pump module 14. Since the timing device 34 may be adjusted to control the amount of water dispensed by the pump 32, and the delay between operations, there may be some cases where it may also be necessary to utilize an alternate steam plate with a different number and/or size of openings.

The steaming module 16 may normally be placed on a table or countertop in the food preparation area. The pump module 14 and water reservoir 12 may also be placed on the same surface, or in another proximate location, such as on a shelf underneath the work surface. The warming system 10 requires a suitable electrical supply of 115 volts and a 20-amp circuit, although other volt/ampere configurations may be used.

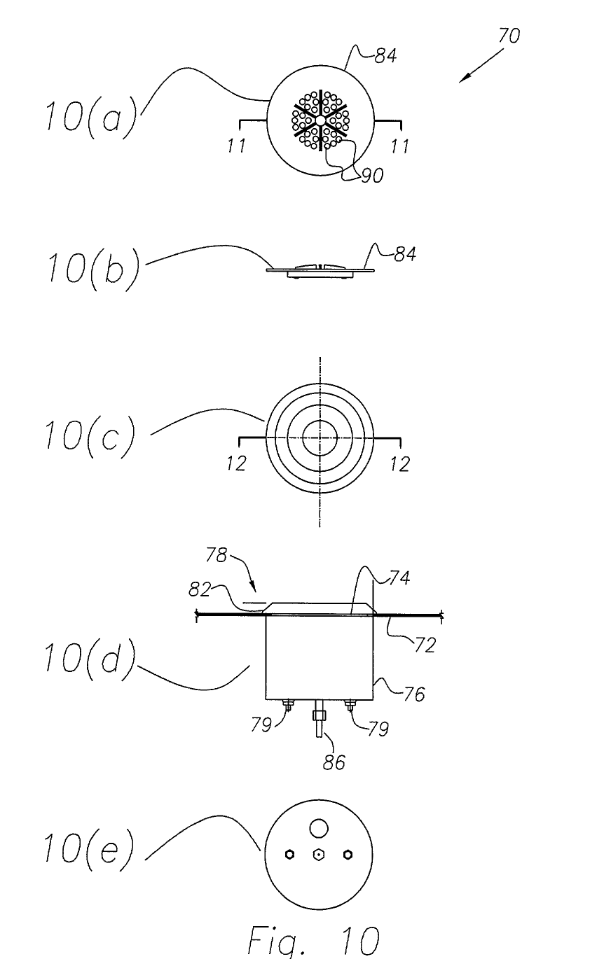

In another embodiment of the present invention, the steaming module 70 may be mounted to a counter top 72 as shown in FIG. 10. The steaming module 70 may include a notch 74 shaped to contact the counter top 72. The notch 72 is formed between the steaming module housing 76 and the steamer head 78 or heating element.

The steaming module 70 may be mounted to the countertop by positioning the base of the steamer head 78 into the hole in the counter top 72. The housing 76 is then placed under the counter top 72 and removably attached to the steamer head 78 using any suitable means, such as bolts 78. The steamer head 78 includes bolt holes (not shown) shaped to receive bolts 78 passing from the bottom of the housing 76. The bolts 78 are tightened to the base of the housing 76. An outer rim 82 of the steamer head 78 supports the steaming module 70 on the counter top 72. After mounting, the steam plate 84 may then be removably attached to the steamer module 70. In addition, the water transport tube 86 may enter the steaming module 70 from the base of the steaming module 70.

Operation of the warming system 10 of the present invention may be understood by referring once again to FIGS. 1-9. The food warmer system 10 according to the present invention may be operated by initially filling the water reservoir 12 with a liquid, for example water. The power cord (not shown) is then connected to the appropriate circuit, and the ON-OFF switch 36 of the pump module 14 may be pressed to the ON position. Turning on the system 10, will activate the HEAT ON indicator light 48. The READY indicator light 50 will light, when the heating element 52 is warmed up to operating temperature.

When the HEAT ON indicator light 48 goes out, the steaming module 16 is at operating temperature. At this point it is necessary to press and hold down the operating switch button 40 until the pump 32 has filled the water transport tube 26 with water. The tube 26 may be considered filled, when steam is observed exiting from the openings 58 in the portion plate 46. At this point the warming system 10 is ready for use.

To use the system 10, a quantity of food may be placed on the portion plate 10 and the operating switch button 46 may be pressed. Pressing the button 46 activates the timing device 34 which operates the pump 32 for a specified time period. The pump 32 will deliver a set quantity of water through the tube 26 into the steaming module 16. The READY light 50 will go out and the steam will be applied to the food portion through the openings 58 in the portion plate 46. When the READY light 50 comes on, the steaming module 16 has completed a steam cycle, and the food portion can be removed.

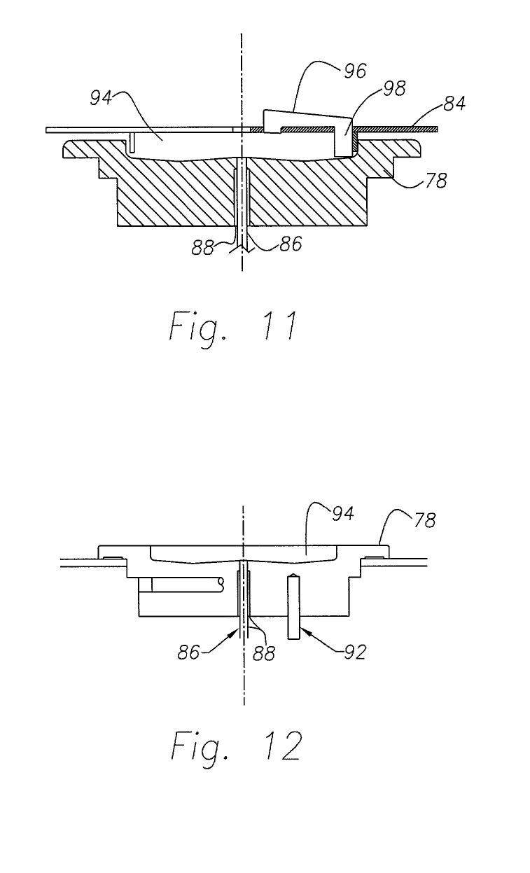

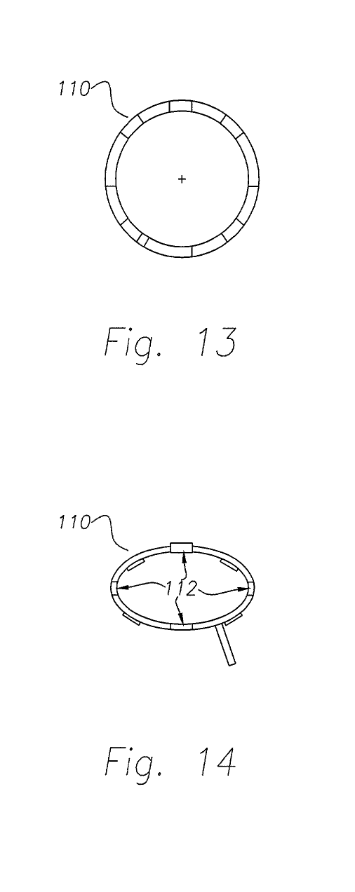

The operation of the steaming module 10 may be explained with reference to FIGS. 11 and 12. The steaming module 70 may include a passage 88 shaped to receive a water transport tube 86. The passage 88 may penetrate the steamer head 78. The steaming module 70 may also include a temperature sensor 92 that monitors the temperature of the steamer head 78.

The steamer head 78 includes a steam chamber 94. When the portion plate 84 is removably attached to the steamer head 78, the steam chamber 94 may become sealed so that liquid does not contact the food. The portion plate 84 may also include at least one fin 96 that includes a leg portion 98 for positioning within the steam chamber. The leg portion 98 helps to seat the portion plate 84 above the steamer head 78.

In operation, the steamer head 78 is preheated to a temperature which will rapidly convert the liquid in the steam chamber 94 to a vapor. The temperature sensor 92 will monitor the steamer head temperature and activate the READY light when the steamer head 78 reaches the preheated temperature suitable for converting the liquid to vapor. The operator will then press the operating system button to activate the pump. The operation of the pump transports a preselected amount of liquid through the tube 86, and the liquid exits the tube 86 into the steam chamber 94. The liquid will then be rapidly vaporized upon contact with the preheated steamer head 78, and the vapor will exit the steam chamber 102 through the holes 90 in the portion plate 84. Any liquid not vaporized will be diverted by the diverter plate 96 away from the food on the portion plate 84.

When using the warming system 10, according to the present invention, the food or product serving to be warmed, may be placed onto the portion plate 46 as shown in FIGS. 1-9. For example, the food product may be any food product, such as sliced meat, vegetables, or buns. The operating system button 40 is then pressed to actuate the steam cycle and warm the food or product serving. Approximately six seconds should pass to allow for the complete exhaust of the steam, before removing the food or product serving from the steamer. When the READY light 50 illuminates, the steaming module 16 is ready for the next serving of food or product serving to be warmed.

The present invention may also incorporate any conventional weight or load measuring device, such as, load cells, mechanical scales and electrical scales shown in FIGS. 13 and 14. The load cell 110 may be donut shaped and positioned outside of the steamer head of the steaming module. The steamer head may support the load cell 110 and the portion plate when placed on the steamer head. The load cell may include loading points 112. Preferably, the load cell is electrically connected to a digital LED for the purpose of displaying the weight of the food or product serving disposed on the portion plate. The use of a load cell allows the food to be portioned controlled prior to heating.

While we have shown and described several embodiments in accordance with our invention, it is to be clearly understood that the same are susceptible to numerous changes apparent to one skilled in the art. Therefore, we do not wish to be limited to the details shown and described but intend to show all changes and modifications which come within the scope of the appended claims.

What is claimed is:

1. A system for heating food comprising:
a steaming module for converting a liquid to a vapor, said steaming module comprising a heat source positioned beneath a cavity;
a pump module for transporting liquid to said cavity from a reservoir;
a portion plate comprising holes positioned above said steaming module; and
wherein liquid transported to said cavity is vaporized upon contact with said heat source and the vapor exits through said holes of said portion plate, thereby warming the food product disposed on said portion plate.

2. The system of claim 1, wherein said heat source is heatable in a range above and below the boiling point of said liquid.

3. The system of claim 1, wherein said heat source comprises a steamer head.

4. The system of claim 1, wherein said reservoir comprises a container that includes an outlet in fluid communication with said pump module.

5. The system of claim 1, wherein said pump module comprises a peristaltic pump.

6. The system of claim 1, wherein said pump module comprises an activation timer.

7. The system of claim 1, further comprising a remote operating switch for activating said pump.

8. The system of claim 1, wherein said liquid is water, and said vapor is steam.

9. The system of claim 1, wherein said steaming module further comprises a load cell for determining the weight of the food on said portion plate.

10. The system of claim 1, wherein said steaming module further comprises a ring of thermal insulating material for insulating said portion plate from said heat source.

11. The system of claim 1, wherein said cavity is bordered by the upper surface of said heat source, the inner circumferential surface of said ring, and below the lower surface of said portion plate.

12. The system of claim 10, wherein said ring is teflon, and said teflon ring seals said cavity to prevent escaping of vapor therefrom.

13. The system of claim 1, wherein the steaming module further comprises a diverter plate for preventing water from exiting through said portion plate holes.

14. A steaming module for warming food comprising:
a heating means in fluid communication with a cavity disposed in said heating means and wherein said heating means is capable of being heated to a predetermined temperature;
a portion plate comprising outlet ports, wherein said portion plate is disposed on said heating means;
an inlet port for admitting a liquid into said cavity such that said liquid comes into contact with said heating means;
wherein said liquid is vaporized and the vapor exits through said outlet ports in said portion plate.

15. The steaming module of claim 14, wherein said potion plate further comprises fins on the upper surface.

16. The steaming module of claim 14, wherein said steaming module further comprises a temperature sensor to monitor the temperature of said heating means.

17. A method for providing heated vapor to warm food product comprising:
providing a portion plate with outlet ports positioned above a heating element;
preheating the heating element above the boiling point of a liquid to be vaporized;
carrying said liquid to contact said heating element whereby said liquid undertakes a phase change to vapor; and
directing the vapor through said outlet ports of said portion plate, whereby food product, placed on said portion plate, is warmed.

18. The method of claim 17, wherein said liquid is water, and said vapor is steam.

19. The method of claim 17, wherein an activation timer controls the amount of liquid to be placed in contact with said heating element.
